(19) United States
(12) Patent Application Publication
(10) Pub. No.: US 2012/0095596 A1
(43) Pub. Date: Apr. 19, 2012

(54) MODULAR APPARATUSES

(75) Inventors: Matthew Denver Cole, Fort Collins, CO (US); Paul Damon Linnebur, Milliken, CO (US); Marc Thomas Rood, Broomfield, CO (US); Matthew David Zankey, Denver, CO (US); Justin Matthew Vallely, Fort Collins, CO (US)

(73) Assignee: Special Applications Technology, Inc., Loveland, CO (US)

(21) Appl. No.: 13/212,159

(22) Filed: Aug. 17, 2011

Related U.S. Application Data
(60) Provisional application No. 61/393,353, filed on Oct. 14, 2010.

(51) Int. Cl. B25J 9/20; B25J 19/02; F16J 15/36; B25J 9/14; B25J 17/02

(52) U.S. Cl. 700/253; 74/490.04; 74/490.06; 277/393; 901/21; 901/29; 901/46; 901/48

(57) ABSTRACT

The present disclosure introduces modular apparatuses for mechanical devices. In one embodiment, a chain joint is described. The chain joint may include a rotating drum having an attachment point. Further, the chain joint may also include hydraulic cylinders connected to the rotating drum. Lengths of chain may be used to connect the hydraulic cylinders to the rotating drum via the attachment point. Another embodiment describes a robotic apparatus incorporating the chain joint. Other embodiments are also described.

### CROSS-REFERENCE TO RELATED APPLICATION

This application claims the benefit of U.S. Provisional Application No. 61/393,353 filed Oct. 14, 2010, titled “Powered Remote Manipulator,” which is hereby incorporated in its entirety by reference.

### TECHNICAL FIELD

The present disclosure relates generally to mechanical devices, and more particularly, modular apparatuses.

### BACKGROUND

There are numerous tasks and chores that may require humans to utilize mechanical apparatuses in order to complete. Some reasons for this may include strength, maneuverability, functionality, efficiency, and the presence of dangerous or hazardous conditions, among others. For example, decontamination and decommissioning of the world's most hazardous environments can require the use of mechanical apparatuses. Advancement in technology has resulted in more modular and scalable solutions to today's problems.

### SUMMARY

The present disclosure introduces modular apparatuses for mechanical devices. In one embodiment, a chain joint is described. The chain joint may include a rotating drum having an attachment point. Further, the chain joint may also include hydraulic cylinders connected to the rotating drum. Lengths of chain may be used to connect the hydraulic cylinders to the rotating drum via the attachment point. Another embodiment describes a robotic apparatus incorporating the chain joint. Other embodiments are also described.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

Various embodiments will now be described in detail with reference to the accompanying drawings.

FIG. 1 is an exemplary view of a chain joint, according to an example embodiment.

FIG. 2 is a schematic view partially in section of a valve set configuration, according to an example embodiment.

FIG. 3 is a perspective view of a remote controllable robotic apparatus, according to an example embodiment.

FIG. 4 is a schematic view partially in section of an isolation circuit, according to an example embodiment.

FIG. 5 is a perspective view of a powered remote apparatus, according to an example embodiment.

FIG. 6 is a perspective view of a containment system for a robotic arm, according to an example embodiment.

FIG. 7 is a perspective view, partially in section of a containment system, according to an example embodiment.

FIG. 8 is a perspective view, partially in section of a containment system, according to an example embodiment.

FIG. 9 is a side view of a powered remote manipulator, according to an example embodiment.

FIG. 10 is a cutaway view of a mounted powered remote manipulator, according to an example embodiment.

FIG. 11 is a perspective view of a crane deployed powered remote manipulator, according to an example embodiment.

FIG. 12 is an exploded view of a shoulder joint, according to an example embodiment.

FIG. 13 is a side view of an alternative embodiment of a shoulder joint, according to an example embodiment.

### DETAILED DESCRIPTION

The following detailed description is divided into three sections. A first section presents a system level overview of the modular apparatuses. The following section describes example implementations of the modular apparatuses. The final section presents the claims.

### System Level Overview

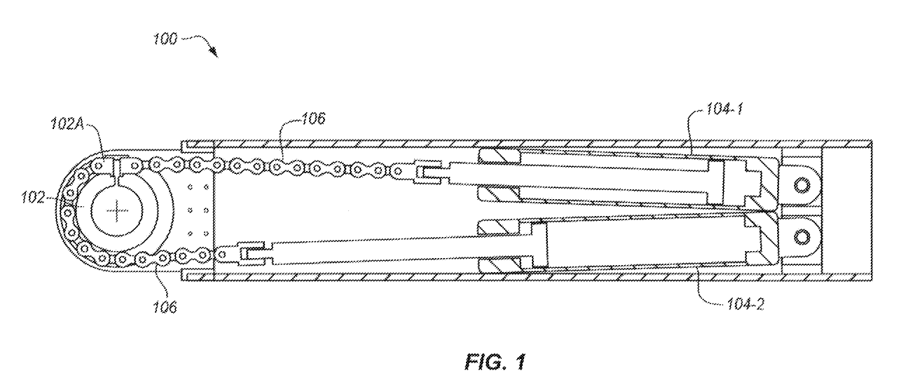

FIG. 1 is an exemplary view of a chain joint, according to an example embodiment. The chain joint 100 comprises a rotating drum 102, hydraulic cylinders 104 (e.g., 104-1 and 104-2), and multiple lengths of chain 106. In some embodiments, the chain joint may be a component of a larger apparatus. Specific applications of the chain joint 100 may include but are not limited to an elbow joint, a shoulder joint, and a wrist joint.

The chain joint 100 may be powered by hydraulic cylinders 104 attached to the rotating drum 102 via the lengths of chain 106. The rotating drum 102 may have an attachment point 102a, allowing the hydraulic cylinders 104 to be attached to the rotating drum 102. In an example embodiment, each of the lengths of chain 106 may wrap around an opposing side of the rotating drum 102 to the attachment point 102a. This configuration may give the chain joint 100 constant torque over one-hundred and eighty degrees (180°) of motion.

In one embodiment, at least two hydraulic cylinders 104 may be included in the chain joint 100. The hydraulic cylinders 104 may be linear. Any style of hydraulic cylinder may be used for the hydraulic cylinders 104 of the chain joint 100 including tie rod style cylinders and welded body style cylinders, among others.

The lengths of chain 106 connecting the rotating drum 102 to the hydraulic cylinders 104 may be made of any material and consist of two or more links. In a particular embodiment, at least two lengths of chain may be used to connect the rotating drum 102 to the hydraulic cylinders 104. In one embodiment, the lengths of chain 106 may be comprised of leaf chain.

In a particular embodiment, the chain joint 100 may be used in a robotic arm apparatus. The robotic arm may be lowered by retracting a bottom hydraulic cylinder 104, creating counterclockwise rotation of the rotating drum 102 thereby lowering the robotic arm.

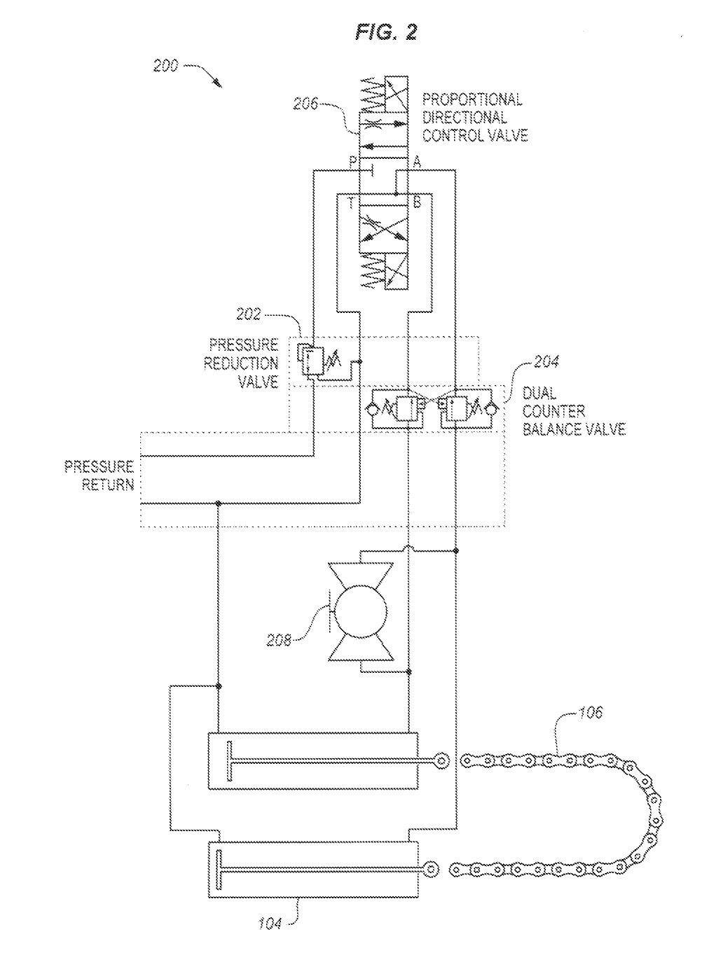

An alternative embodiment of the chain joint 100 may further comprise a valve set to control the chain joint 100. The valve set applied to the chain joint 100 is described in more detail in the description of FIG. 2 below.

FIG. 2 is a schematic view, partially in section of a valve set configuration, according to an example embodiment. The valve set 200 may control a chain joint such as the chain joint 100 described in FIG. 1. The valve set 200 comprises a pressure reduction valve 202, a dual counter balance valve 204, and a proportional directional control valve 206. The pressure reduction valve 202 may be attached to the hydraulic cylinders 104 (as referenced in FIG. 1) to limit the pressure of the hydraulic cylinders 104. The pressure reduction valve 202 limits the torque on the chain joint 100 created by the hydraulic cylinders 104. In an alternative embodiment, the valve 202 may be replaced by a dual pressure reducing valve may be used to effect the pressures on ports A and B differently to allow for different forces in one direction vs. the other.

A dual counter balance valve 204 may also be attached to the hydraulic cylinders 104. The dual counter balance valve 204 may maintain tension in the lengths of chain 106 connecting the hydraulic cylinders to the rotating drum 102. As previously mentioned, the chain joint 100 may be utilized in a robotic arm apparatus. The dual counter balance valve 204 may be used to control the overrunning load when lowering the robotic arm apparatus as well as maintaining tension in the lengths of chain 106. Additionally, the dual counter balance valve 204 may also be used as a load holding valve to hold the robotic arm apparatus in position with very little drift when the chain joint 100 is not moving or the robotic apparatus is not powered on.

Furthermore, a proportional directional control valve 206 may be attached to the hydraulic cylinders 104 to control the flow of hydraulic oil through the chain joint 100. The proportional directional control valve 206 controls the meters in and float center of the hydraulic oil. The proportional directional control valve 206 is designed to work particularly well with the dual counter balance valve 204. The proportional directional control valve 206 has very low flow characteristics that may allow a connected robotic arm apparatus to make precise movements.

In an alternative embodiment, the valve set 200 may also include a ball valve 208 connected to the hydraulic cylinders 104. The ball valve 208 may allow the chain joint 100 to move freely to external forces. The ball valve 208 may be useful during installation and emergency recovery of a chain joint 100.

In another alternative embodiment, the valve set 200 may be located outside of a robotic arm apparatus. This may make it possible for an operator to override the valve settings in case of failure of chain joint 100.

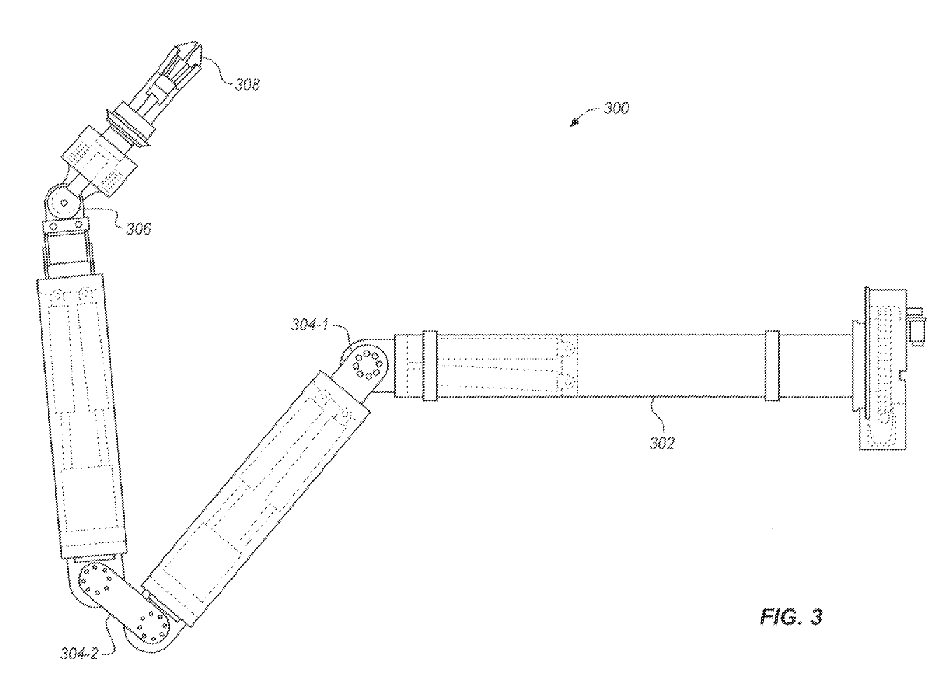

FIG. 3 is a perspective view of a remote controllable robotic apparatus, according to an example embodiment. The remote controllable robotic apparatus 300 comprises a frame 302, at least two chain joints 304 coupled to the frame 302, a plurality of actuators 306 coupled to the frame 302, and an attachable end effector 308 connected to the plurality of actuators 306. In one example embodiment, the remote controllable robotic apparatus 300 may be a powered remote manipulator (“PRM”). Refer to the “example implementations” section of the detailed description for further detail regarding the PRM.

The frame 302 of the remote controllable robotic apparatus 300 may be constructed out of radiation tolerant material. In one embodiment, the radiation tolerant material of the frame 302 may be carbon fiber. Using carbon fiber to fabricate the frame 302 may cut down on the weight and material costs of the remote controllable robotic apparatus 300, as well as the strength needed to lift large objects. In an alternative embodiment, the frame 302 may be constructed out of hollow aluminum tubes for buoyancy purposes in underwater applications of the remote controllable robotic apparatus 300.

The remote controllable robotic apparatus 300 further includes at least two chain joints 304 (e.g., 304-1 and 304-2) coupled to the frame 302. Each of the at least two chain joints 304 represent an example embodiment of the chain joint 100 described in FIG. 1. Each chain joint of the at least two chain joints 304 includes a rotating drum having an attachment point, at least two hydraulic cylinders attached to the rotating drum, and at least two lengths of chain connecting the at least two hydraulic cylinders to the rotating drum via the attachment point. In one embodiment, the at least two chain joints 304 may act as a shoulder joint and an elbow joint. In an alternative embodiment, the remote controllable robotic apparatus 300 may include at least three chain joints 304 acting as a shoulder joint and two elbow joints. Alternatively, the chain joints 304 may be powered by piston-based rotary actuators and/or electric motor drives.

The remote controllable robotic apparatus 300 further includes a plurality of actuators 306 coupled to the frame 302. In an example embodiment, the plurality of actuators 306 may combine to act as a wrist joint for the remote controllable robotic apparatus 300. The plurality of actuators 306 may be arranged in vertical, horizontal, and axial configurations to allow for pitch, yaw, and roll capabilities. In one embodiment, the plurality of actuators 306 may be linear. In another embodiment, the plurality of actuators 306 may be rotary.

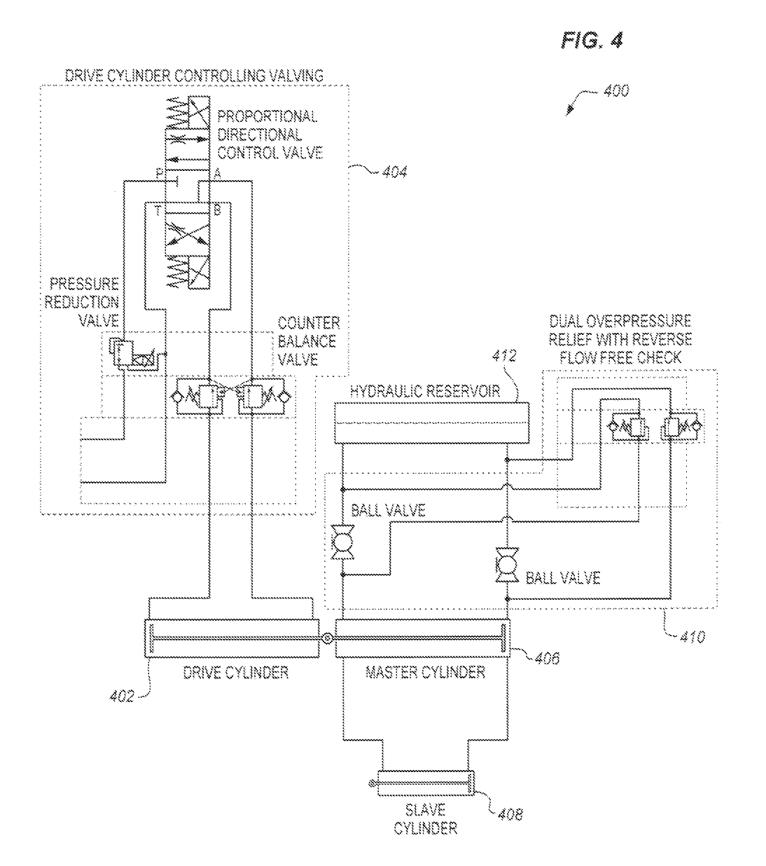

The remote controllable robotic apparatus 300 further includes an attachable end effector 308 connected to the plurality of actuators 306. The attachable end effector 308 may be powered by a combination of hydraulic cylinders, piston-based rotary actuators and/or electric motor drives. The attachable end effector 308 of the remote controllable robotic apparatus 300 may have quick change tool capabilities. Quick change tool methods are utilized to allow for many different attachments including, but not limited to: grippers, shears, hydrolasing heads, water-jet cutters, dry media blasters, saws, and a pneumatic torque wrench, among others. In a particular embodiment, the attachable end effector 308 may be a hydraulic actuated gripper. In yet another embodiment, the attachable end effector 308 may include an isolation circuit. The isolation circuit may be used to limit the spread of contaminants beyond the attachable end effector 308. The isolation circuit of the attachable end effector 308 is described in more detail in the description of FIG. 4 below.

An alternative embodiment of the remote controllable robotic apparatus 300 may include a position feedback module linked to the remote controllable robotic apparatus 300. The position feedback module may allow implementation of inverse kinematics control of the at least two chain joints 304, the plurality of actuators 306, and the attachable end effector 308. The position feedback module may allow an operator of a remote controllable robotic apparatus 300 so that movements may be smooth and linear. An alternative embodiment of the remote controllable robotic apparatus 300 may include force sensors, pressure sensors and torque sensors linked to the remote controllable robotics apparatus 300. The force/pressure feedback module may be combined with the position feedback module to allow implementation of arm protection algorithms. These algorithms may look at the position feedback module to determine the current orientation of the remote controllable robotic apparatus 300 and determine the anticipated force/pressure that may be seen for each joint. Sensor errors may be taken into account and a maximum allowable force/pressure can be calculated. If the sensor readings exceed the maximum allowable, the remote controllable robotic apparatus 300 may be disabled to prevent the remote controllable robotic apparatus 300 from being damaged.

FIG. 4 is a schematic view, partially in section of an isolation circuit, according to an example embodiment. As previously mentioned, the isolation circuit 400 may be used to limit the spread of contaminants beyond the attachable end effector 308 as described in FIG. 3. The isolation circuit 400 may comprise a drive cylinder 402, drive cylinder controlling valving 404 connected to the drive cylinder 402, a master cylinder 406 connected to the drive cylinder 402, a slave cylinder 408 coupled to the master cylinder 406, a master/slave controlling valve set 410 connected to the master and slave cylinders, and a hydraulic reservoir 412 connected to the master/slave controlling valve set 410.

The drive cylinder 402 and the drive cylinder controlling valving 404 may be positioned on a clean side of the isolation circuit 400, separate from potential contaminated hydraulic fluid on the master/slave side of the isolation circuit 400. The drive cylinder 402 may be connected to the master cylinder 406 only through a mechanical link, providing a physical barrier between contaminated fluid and clean hydraulic fluid. Further, the drive cylinder 402 is controlled by the drive cylinder controlling valving 404 which may be used to actuate the drive cylinder 402 back and forth, and hold the drive cylinder 402 in place when unpowered. The drive cylinder controlling valving 404 includes a directional control valve, a counterbalance valve, and a pressure reduction valve.

The master cylinder 406 may be mechanically driven by the drive cylinder 402. Furthermore, the master cylinder 406 may be hydraulically coupled to the slave cylinder 408. Displacement ratios of the master cylinder 406 and slave cylinder 408 may be equal to allow hydraulic oil to move freely between the two cylinders.

The master/slave controlling valve set 410 may include a dual overpressure relief valve and two ball valves. The dual overpressure relief valve may have reverse flow free checks which prevent the contaminated side of the isolation circuit 400 from becoming over pressurized. The two ball valves may allow an operator of the remote controllable robotic apparatus 300 (as described in FIG. 3) to purge the isolation circuit 400 of air and realign strokes of the master cylinder 406 and the slave cylinder 408. A hydraulic reservoir 412 may be used to accumulate excess oil and allow the system to be purged of air.

In the particular embodiment where the attachable end effector 308 is a hydraulic actuated gripper, the directional control valve of the drive cylinder controlling valving 404 may be used to close the gripper during normal operation of the remote controllable robotic apparatus 300. The directional control valve may force hydraulic oil into a butt side of the drive cylinder 402, driving the rod of the cylinder out. This in turn may push the rod of the master into the cylinder, pushing oil out of a butt side of the master cylinder 406. The hydraulic fluid may flow into a butt side of the slave cylinder 408, pushing the rod out and closing the gripper.

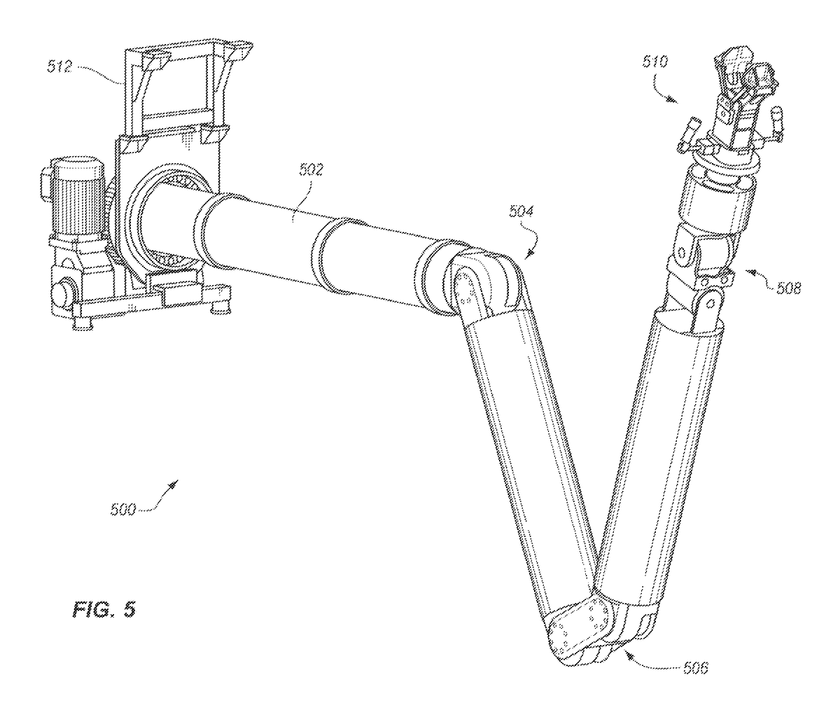

FIG. 5 is a perspective view of a powered remote manipulator, according to an example embodiment. The powered remote manipulator 500 comprises a frame 502, a shoulder joint 504 coupled to the frame 502, an elbow joint 506 coupled to the frame 502, a wrist joint 508 coupled to the frame 502, and an attachable end effector 510 connected to the wrist joint 508. The powered remote manipulator may be the powered remote manipulator (PRM) referenced in the “example implementations” section of this detailed description. Refer to the “example implementations” section of the detailed description for further detail regarding the PRM.

The frame 502 of the powered remote manipulator 500 may be constructed out of radiation tolerant material. In one embodiment, the radiation tolerant material of the frame 502 may be carbon fiber. In an alternative embodiment, the frame 502 may be constructed out of sealed, hollow tubes (e.g., aluminum tubes) for buoyancy purposes in underwater applications of the powered remote manipulator 500.

The shoulder joint 504 may be coupled to the frame 502 and have at least two hydraulic cylinders connecting to a rotating drum. In one embodiment, the shoulder joint 504 may be configured like the chain joint 100 described in FIG. 1. In an alternative embodiment, the at least two hydraulic cylinders of the shoulder joint 504 may be directly connected to the rotating drum. This configuration trades a reduced range of motion of the shoulder joint 504 for a higher load capacity by allowing both hydraulic cylinders to exert force onto the rotating drum thereby increase output torque on the shoulder joint 504. The shoulder joint 504 allows for very high torque outputs because it can push and pull concurrently. In one embodiment, rotation of the shoulder joint 504 may be powered by a motor powered slewing drive. In an alternative embodiment, the rotation of the shoulder joint 504 may be powered by a hydraulic actuator.

The elbow joint 506 may also be coupled to the frame 502 and have at least two hydraulic cylinders attached to a rotating drum via at least two lengths of chain. The shoulder joint 504 may be configured like the chain joint 100 described in FIG. 1.

Additionally, the powered remote manipulator 500 may include a wrist joint 508 coupled to the frame 502 and including a plurality of actuators. The plurality of actuators of the wrist joint 508 may be arranged in vertical, horizontal and axial configurations to allow pitch, yaw and roll capabilities. In one embodiment, the plurality of actuators may be linear. In an alternative embodiment, the plurality of actuators may be rotary.

The attachable end effector 510 having an isolation circuit may be connected to the wrist joint 508 of the powered remote manipulator 500. The attachable end effector 510 and its components may be like the attachable end effector 308 described in FIG. 3.

An alternative embodiment of the powered remote manipulator 500 may further include a mounting attachment 512. The mounting attachment may allow the powered remote manipulator 500 to be mounted to a wall, port, container, or any other device. One particular device the powered remote manipulator 500 may be mounted to is a crane.

In another alternative embodiment, the powered remote manipulator 500 may further include an external valve set linked to the shoulder joint 504, the elbow joint 506, the wrist joint 508, and the attachable end effector 510. The external valve set may allow an operator of the powered remote manipulator 500 to override the valve settings in case of joint failure. In one particular embodiment, all of the hydraulic joints of the powered remote manipulator 500 may be plumbed using custom three/thirty-second inch ( 3/32″) hoses engineered for higher radiation tolerance than standard micro hoses. The three/thirty-second inch ( 3/32″) hoses makes it possible to keep the entire valve set external to the powered remote manipulator 500. This may be done by routing the required number of hoses through the powered remote manipulator 500 producing three (3) benefits. First, the arrangement keeps the valve set away from high radiation and makes them available for any maintenance. Second, it also makes it possible to uninstall the powered remote manipulator 500 under a failed condition. Finally, the small hoses and fittings control the rate of descent of the powered remote manipulator 500 if a hose would happen to burst. Sensors may also be built into the powered remote manipulator 500 to prevent damage under overloaded conditions.

In yet another alternative embodiment, a positional feedback module may be linked to the powered remote manipulator 500 allowing for the implementation of kinematic control of all the joints and the attachable end effector 510.

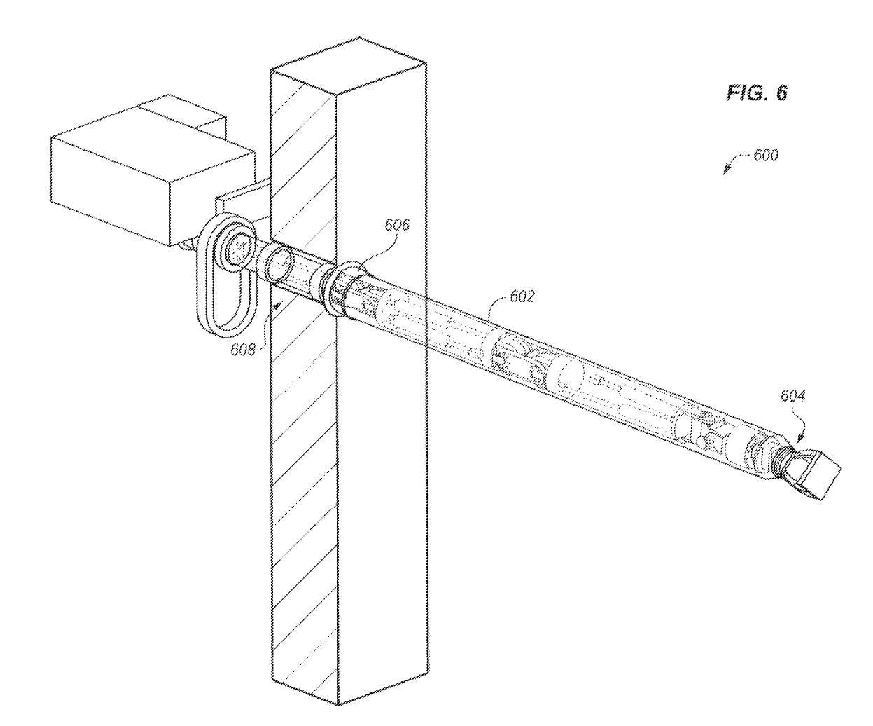

FIG. 6 is a perspective view of a containment system for a robotic arm, according to an example embodiment. The containment system 600 may be a modular apparatus used to completely seal the remote controllable robotic apparatus 300, the powered remote manipulator 500 (as described in FIG. 5), or any other robotic arm apparatus from airborne contamination. The containment system 600 comprises a gaiter or boot 602 covering a robotic arm, a sealed bearing clamped to the boot 604, and a boot ring 606 clamped to the boot.

The boot 602 covers the robotic arm providing a physical barrier to airborne contamination as it may enter a high radiation room or toxic area. One example of a high radiation room or toxic area may be a hot cell. The robotic arm having the containment system 600 may be placed in the hot cell through a round penetration, a through wall penetration 608. In one embodiment, the boot 602 may be fabricated out of radiation tolerant material. The boot 602 may comprise a gripper side and a wall side.

A sealed bearing 604 may be clamped to the gripper side of the boot 602. The sealed bearing may be designed to allow constrained relative motion between the boot 602 and the robotic arm, specifically an intermediate tool changer, while sealing the robotic arm on the gripper side from airborne contamination. The intermediate tool changer may be exactly like the attachable end effector 308 described in FIG. 3. In a particular embodiment, the intermediate tool changer may be a hydraulic actuated gripper.

A boot ring 606 may be clamped to the wall side of the boot 602. The boot ring 606 may create a wall side seal for the robotic arm from airborne contamination.

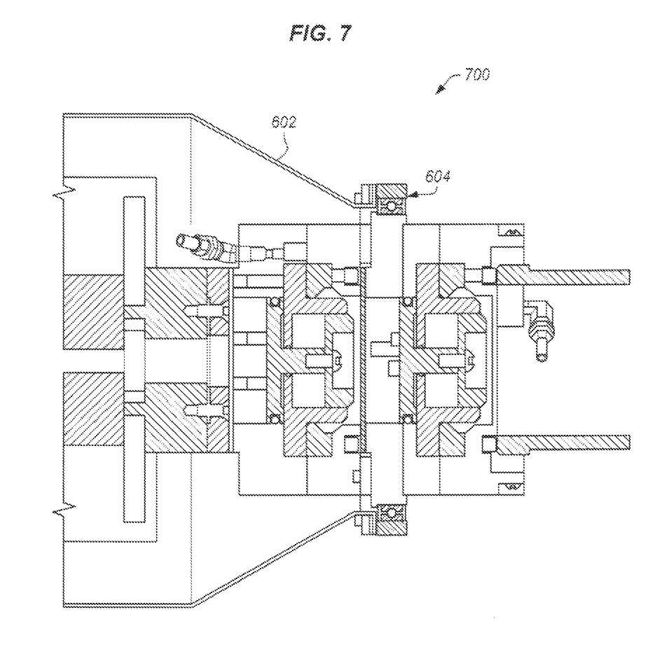

FIG. 7 is a perspective view, partially in section of a containment system, according to an example embodiment. The containment system 700 illustrates a closer look at the gripper side of the boot 602 and its interaction with the sealed bearing 604. The gripper side of the boot 602 is clamped to the sealed bearing 604. The sealed bearing 604 allows the robotic arm to rotate and re-orient itself without twisting the boot 602. When the robotic arm is to be removed from a hot cell, the hydraulic actuated gripper as well as the intermediate tool changer remain in the hot cell with the boot 602 and contamination is maintained.

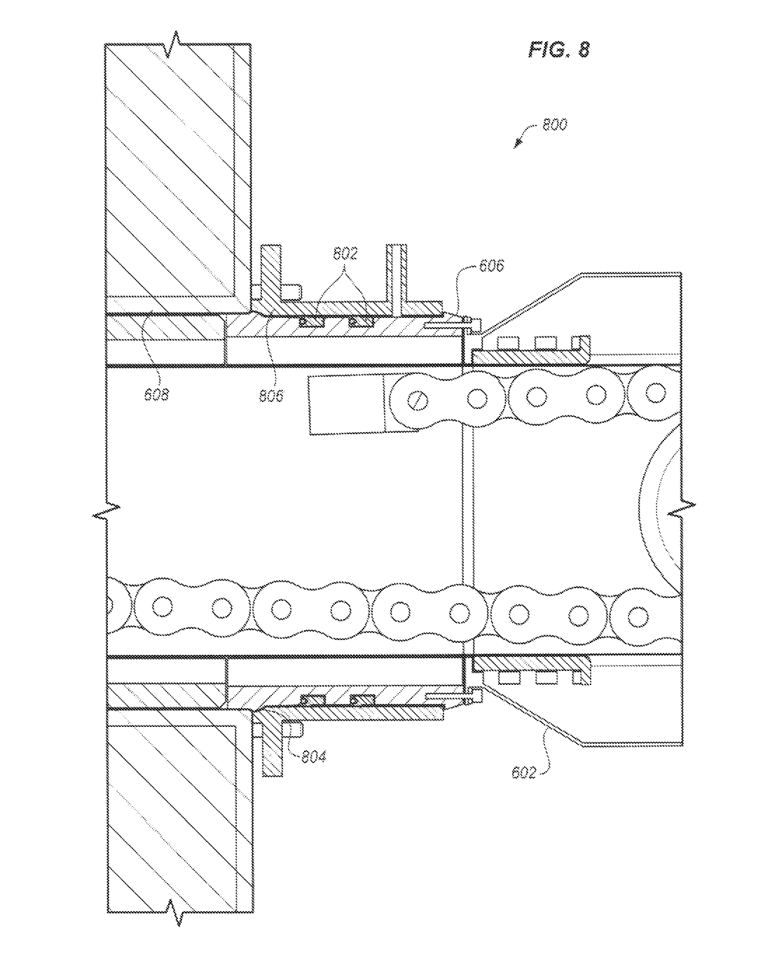

FIG. 8 is a perspective view, partially in section of a containment system, according to an example embodiment. The containment system 800 illustrates a closer look at the wall side of the boot 602 and its interaction with the boot ring 606. The wall side of the boot 602 is clamped to the boot ring 606. In one embodiment, the boot ring 606 may be made of a plastic that allows it to serve as a bearing surface for the robotic arm within the through wall penetration 608. The boot ring 606 also includes seals 802 to maintain complete isolation on the interior of the hot cell to the outside of the hot cell. In a particular embodiment, the boot ring 606 may be retained in the through wall penetration 608 and a wall sleeve extension 806 via an interference lip 804. The boot ring 606 may be forcefully installed as to deform the interference lip 804 until it reaches a groove in the interference lip 804 and snaps into place. When a new boot 602 is to be installed, the boot ring 606 on the new boot 602 simply forces the old boot ring 606 out by pushing against a back surface of the old boot ring 606.

### EXEMPLARY IMPLEMENTATIONS

Various examples and embodiments of the present disclosure have been described above. Listed and explained below are alternative embodiments, which incorporate modular apparatuses. Specifically, one alternative embodiment describes a Powered Remote Manipulator (PRM).

### Powered Remote Manipulator (PRM)

A PRM is a scalable and modular apparatus that may be designed and customized to fit jobs of any type and size. Example embodiments of the PRM may be shown in FIGS. 3 and 5. Examples of technologies incorporating the PRM are described in FIGS. 1, 2, 4, and 6-14.

One example industry which may utilize the PRM is the nuclear and hazardous waste industry. In one embodiment, the PRM may be customized with a wide range of applications for decontamination and decommissioning in the most hazardous environments around the world. The PRM's ability to scale and maintain mobility and strength makes it a highly versatile tool to remotely solve some of the most difficult decommissioning problems.

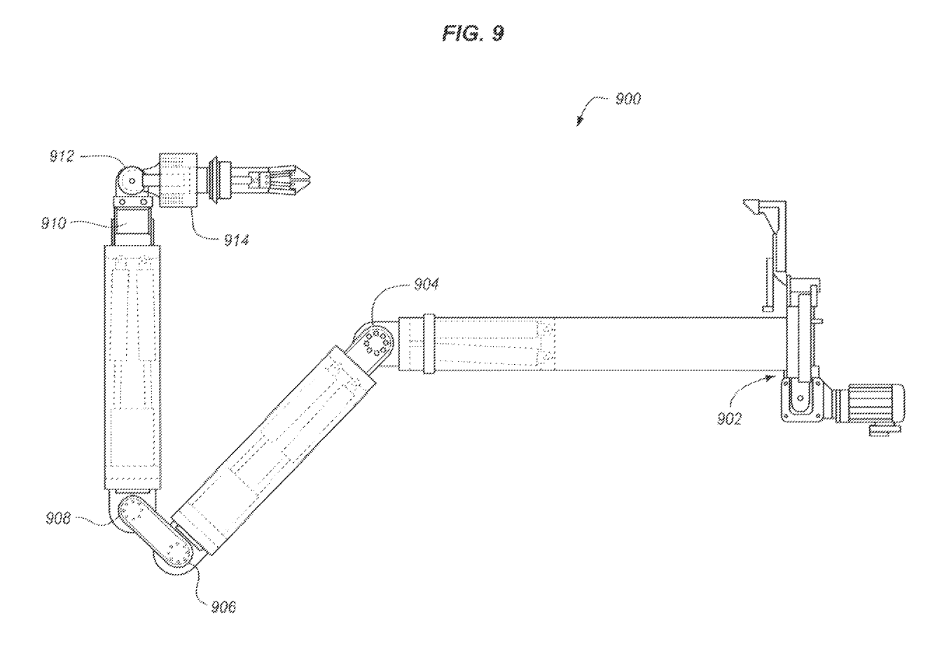

FIG. 9 is a side view of the PRM incorporating a seven-degrees-of-freedom system, according to an example embodiment. Block 900 illustrates the seven-degrees-of-freedom of the PRM. The seven-degrees-of-freedom system may allow the PRM to be a very maneuverable piece of equipment used for packing and lifting waste. Specifically the seven-degrees-of-freedom of the PRM may include: a three-hundred and sixty degree (360°) shoulder rotate (902), a one-hundred degree (100°) to one-hundred and eighty degree (180°) shoulder pivot (904), a first one hundred and eighty degree (180°) elbow chain joint (906), a second one-hundred and eighty degree (180°) elbow chain joint (908), a one-hundred and eighty degree (180°) wrist yaw (910), a one-hundred and eighty degree) (180° wrist pitch (912), and a three-hundred and sixty degree (360°) tool roll (914).

In another embodiment, a PRM may be fabricated out of radiation tolerant material. One example of a radiation tolerant material may be carbon fiber. The PRM may be powered by a combination of hydraulic and electric drives.

### Capabilities of the PRM

In one embodiment, the PRM may possess a ten (10)- to fifteen (15)-foot full reach. The PRM may also include an interchangeable tool attachment. The PRM may also have quick tool change capabilities to suit different types of jobs. One example of the interchangeable tool attachment attached to the PRM may be a hydraulic gripper. The hydraulic gripper may have a grasp that opens over six (6) inches. The PRM may also possess a high handling capacity. In one embodiment, the high handling capacity may be between one-hundred and ten (110) and one-hundred and sixty-eight (168) pounds depending on the orientation and configuration of the customizable PRM.

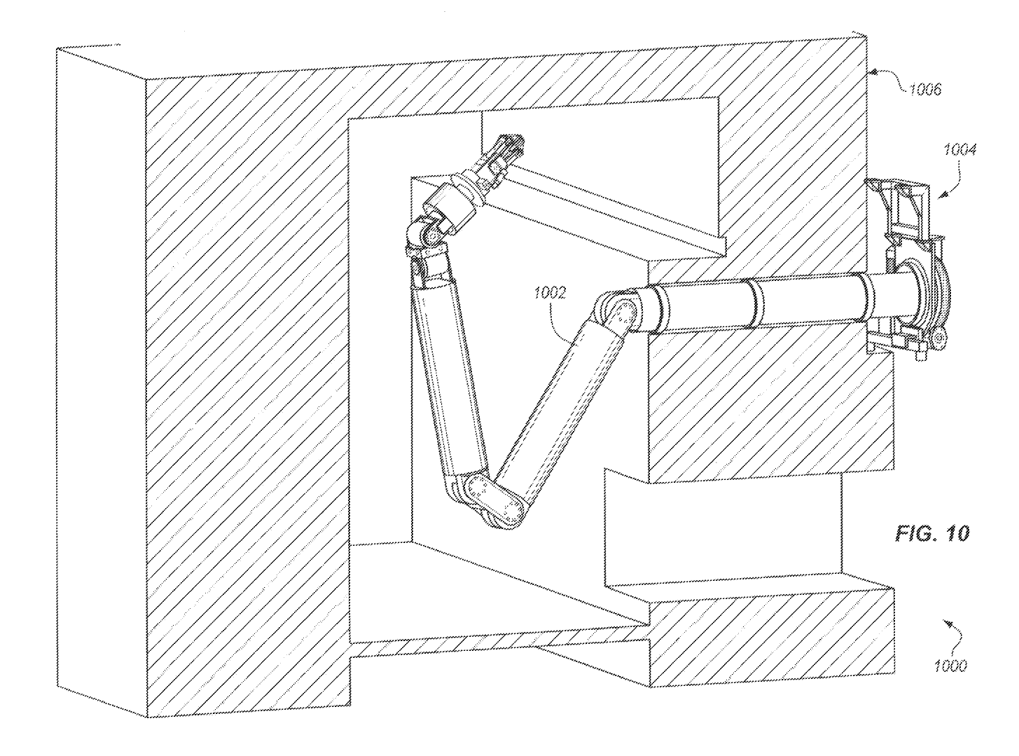

FIG. 10 is a cutaway view of a mounted PRM, according to an example embodiment. At block 1000, the PRM 1002 is mounted in a through-wall penetration/Master Slave Manipulator (“MSM”) port 1004 on a mast/extension, or other industrial equipment. MSMs may be used in the nuclear industry to handle contaminated material. A slave manipulator of an MSM may be connected to the master manipulator by a number of aircraft cables and straps. In an MSM, the slave manipulator mimics the master manipulator. Block 1006 illustrates a partial view of a nuclear radiation containment chamber which the PRM 1002 may work within. Block 1006 may be a hot cell or MSM port.

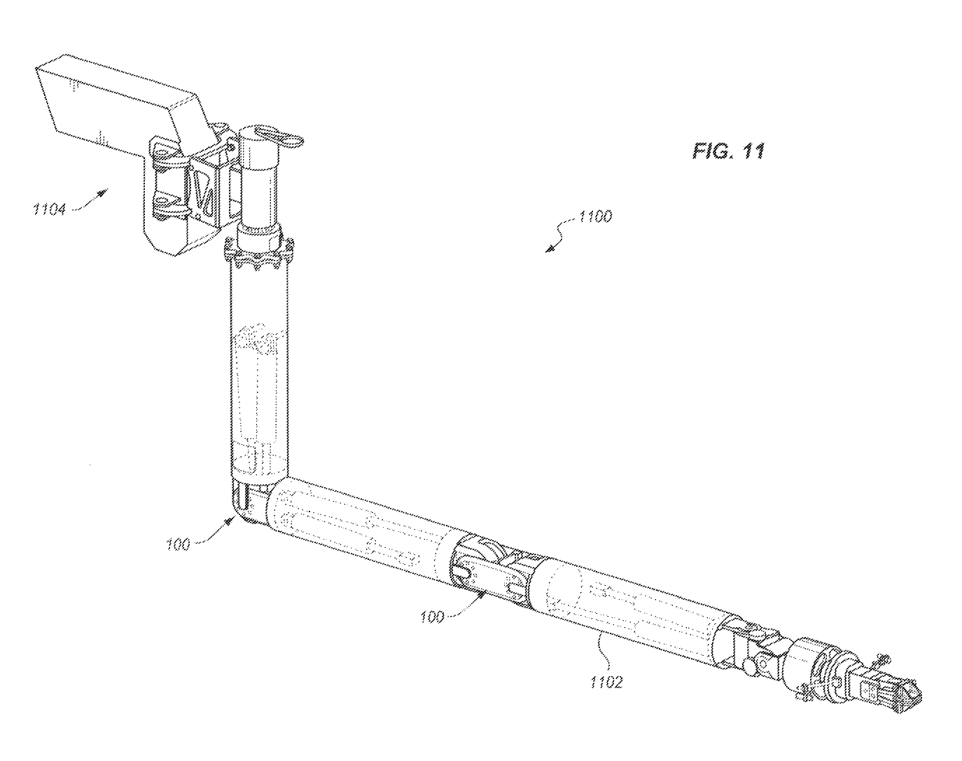

FIG. 11 is a perspective view of a crane deployed powered remote manipulator, according to an example embodiment. Block 1100 illustrates a configuration of the PRM 1102 which may be mounted onto a crane. In one embodiment, the crane may be a spider crane. The PRM 1102 attached to a spider crane may provide the same range of motion and load capabilities as the PRM 1002 shown in FIG. 10 but provides added functionality and design enhancement.

Block 1104 represents an attachment to connect the PRM 1102 to a crane. The PRM 1102 may comprise at least two chain joints 100 as described in FIG. 1.

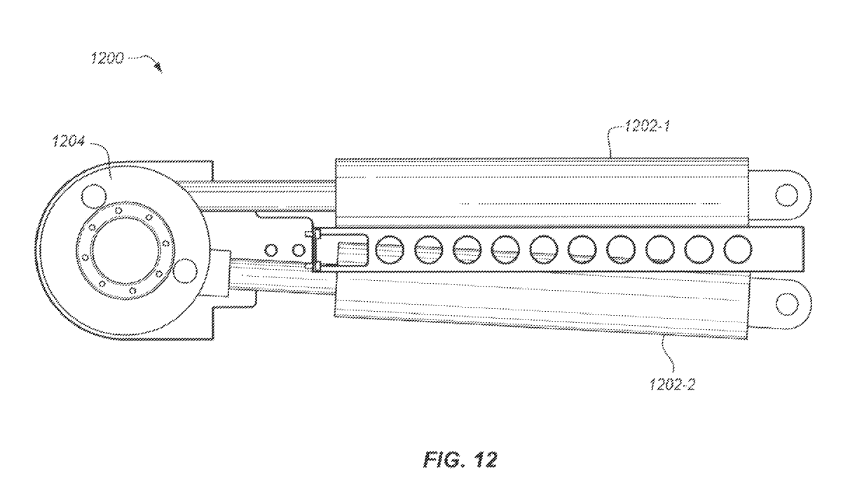

FIG. 12 is an exploded view of a shoulder joint, according to an example embodiment. FIG. 12 illustrates an alternative design of the shoulder joint 1200. The shoulder joint 1200 is similar to the chain joint 100 described in FIG. 1 but trades a reduced range of motion for a higher capacity. In the shoulder joint 1200, hydraulic cylinders 1202 (e.g., 1202-1 and 1202-2) are directly connected to a rotating drum 1204. This allows both hydraulic cylinders 1202 to exert force onto the rotating drum 1204 and increase output torque of the shoulder joint 1200. The shoulder joint 1200 allows for very high torque output because it can push and pull concurrently.

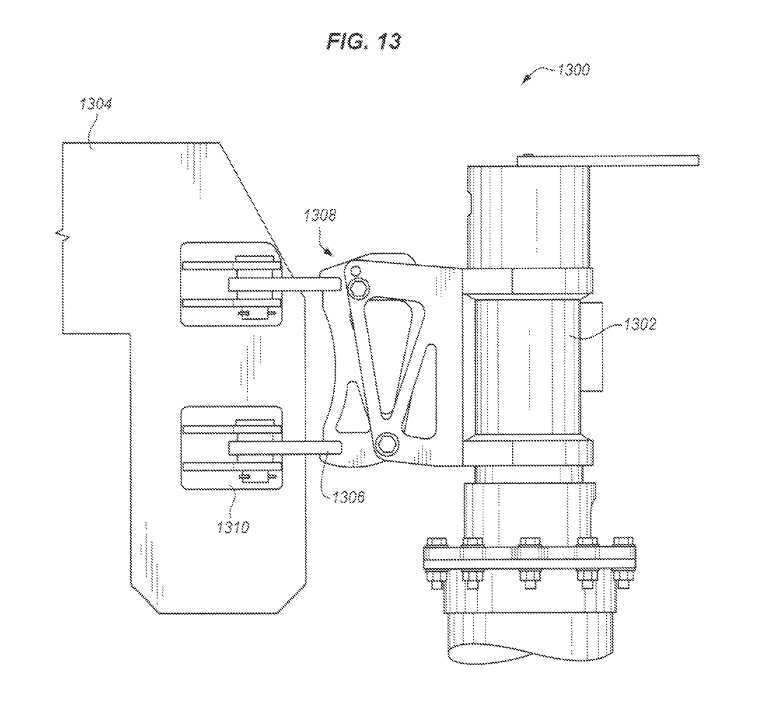

FIG. 13 is a side view of an alternative embodiment of a shoulder joint, according to an example embodiment. The shoulder joint 1300 is powered by a hydraulic actuator 1302 as opposed to a motor powered slewing drive. In one embodiment, the hydraulic actuator 1302 may be a helical hydraulic rotary actuator. The rest of the shoulder joint 1300 remains identical in modes of actuation to previously described embodiments and thus the payloads and range of motion remain unchanged.

Furthermore, FIG. 13 illustrates the shoulder joint 1300 interfacing with a crane attachment 1304. In one embodiment, the crane of the crane attachment 1304 may be a spider crane. A PRM may be connected to the shoulder joint 1300 in which the PRM is a crane deployed PRM such as the PRM 1102 described in FIG. 11. The shoulder joint 1300 is connected to the crane attachment 1304 by a crane interface 1306. Angle adjustment bolts 1308 may be used to connect the hydraulic actuator 1302 to the crane interface 1306. The crane interface 1306 may be connected to the crane attachment 1304 by crane pins 1310.

### Design Modifications and Improvements

Several enhancements to the PRM have been designed in order to increase reliability and functionality of its equipment. These changes include the following:

a) Modular construction to fit various deployment requirements.

b) Buoyancy design to be used for underwater applications.

c) Joint design improvements to increase reliability and functionality.

d) Implementation of Inverse Kinematic control for precision operation.

e) Scaled down design to fit through a 10 inch hot-cell penetrations.

f) Arm overload protection during operations.

### CONCLUSION

This has been a detailed description of some exemplary embodiments of the present disclosure contained within the disclosed subject matter. The detailed description refers to the accompanying drawings that form a part hereof and which show by way of illustration, but not of limitation, some specific embodiments of the present disclosure, including a preferred embodiment. These embodiments are described in sufficient detail to enable those of ordinary skill in the art to understand and implement the present disclosure. Other embodiments may be utilized and changes may be made without departing from the scope of the present disclosure. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In the foregoing Detailed Description, various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, the present disclosure lies in less than all features of a single disclosed embodiment. Thus, the following claims are hereby incorporated into the Detailed Description, with each claim standing on its own as a separate preferred embodiment. It will be readily understood to those skilled in the art that various other changes in the details, material, and arrangements of the parts and method stages which have been described and illustrated in order to explain the nature of this disclosure may be made without departing from the principles and scope as expressed in the subjoined claims.

It is emphasized that the Abstract is provided to comply with 37 C.F.R. §1.72(b) requiring an Abstract that will allow the reader to quickly ascertain the nature and gist of the technical disclosure. It is submitted with the understanding that it will not be used to interpret or limit the scope or meaning of the claims.

What is claimed is:

1. A chain joint comprising:
a rotating drum having an attachment point;
at least two hydraulic cylinders connected to the rotating drum; and
at least two lengths of chain attaching the at least two hydraulic cylinders to the rotating drum via the attachment point.

2. The chain joint of claim 1, further comprising a pressure reduction valve attached to the at least two hydraulic cylinders limiting supply pressure to the at least two hydraulic cylinders.

3. The chain joint of claim 1, further comprising a dual counterbalance valve attached to the at least two hydraulic cylinders to maintain tension in the at least two lengths of chain.

4. The chain joint of claim 1, further comprising a proportional directional control valve attached to the at least two hydraulic cylinders to control flow of hydraulic oil.

5. The chain joint of claim 1 wherein the at least two hydraulic cylinders are linear.

6. The chain joint of claim 1 wherein the at least two lengths of chain are leaf chain.

7. The chain joint of claim 1 wherein each chain of the at least two lengths of chain wraps around an opposing side of the rotating drum attachment point giving the chain joint constant torque over a 180 degree (180°) range of motion.

8. The chain joint of claim 1 wherein the chain joint is an elbow joint.

9. The chain joint of claim 1 wherein the chain joint is a shoulder joint.

10. The chain joint of claim 1 wherein the chain joint is a wrist joint.

11. A remote controllable robotic apparatus comprising:
a frame constructed out of radiation tolerant material;
at least two chain joints coupled to the frame, with each chain joint including a rotating drum having an attachment point, at least two hydraulic cylinders attached to the rotating drum, and at least two lengths of chain connecting the at least two hydraulic cylinders to the rotating drum via the attachment point;
a plurality of actuators coupled to the frame and arranged in vertical, horizontal and axial configurations to allow pitch, yaw and roll capabilities; and
an attachable end effector having an isolation circuit, wherein the attachable end effector is connected to the plurality of actuators.

12. The apparatus of claim 11, further comprising a position feedback module linked to the remote-controllable robotic apparatus allowing for implementation of inverse kinematics control of the at least two chain joints, the plurality of actuators, and the attachable end effector.

13. The apparatus of claim 11, further comprising a force feedback module consisting of force sensors, pressure sensors and torque sensors linked to the remote-controllable robotic apparatus used in conjunction with the position feedback module and a mathematical algorithm to stop motion of the remote-controllable robotic apparatus before it can damage itself.

14. The apparatus of claim 11 wherein the isolation circuit further comprises a drive cylinder, drive cylinder controlling valving connected to the drive cylinder, a master cylinder connected to the drive cylinder, a slave cylinder coupled to the master cylinder, a master/slave controlling valve set connected to the master and slave cylinders, and a hydraulic reservoir connected to the master/slave controlling valve set.

15. The apparatus of claim 11 wherein the frame is constructed out of carbon fiber.

16. The apparatus of claim 11 wherein the frame is constructed out of sealed, hollow aluminum tubes.

17. The apparatus of claim 11 wherein the plurality of actuators are linear.

18. The apparatus of claim 11 wherein the plurality of actuators are rotary.

19. The apparatus of clam 11 wherein the attachable end effector is a hydraulic cylinder actuated gripper.

20. A powered remote manipulator comprising:
a frame constructed out of radiation tolerant material;
a shoulder joint coupled to the frame having at least two hydraulic cylinders connected to a rotating drum;
an elbow joint coupled to the frame having at least two hydraulic cylinders attached to a rotating drum via at least two lengths of chain;
a wrist joint having a plurality of actuators coupled to the frame and arranged in vertical, horizontal and axial configurations to allow pitch, yaw and roll capabilities; and
an attachable end effector having an isolation circuit, wherein the attachable end effector is connected to the wrist joint.

21. The powered remote manipulator of claim 20, further comprising a mounting attachment allowing the remote-powered manipulator to be mounted.

22. The powered remote manipulator of claim 20, further comprising an external valve set linked to the shoulder joint, the elbow joint, the wrist joint, and the attachable end effector, allowing an operator of the remote-powered manipulator to override valve settings in case of joint failure.

23. The powered remote manipulator of claim 20, further comprising a positional feedback module linked to the powered remote manipulator allowing for implementation of inverse kinematic control of the shoulder joint, the elbow joint, the wrist joint, and the attachable end effector.

24. The powered remote manipulator of claim 20, further comprising a force feedback module consisting of force sensors, pressure sensors and torque sensors linked to the remote-controllable robotic apparatus used in conjunction with the position feedback module and a mathematical algorithm to stop motion of the remote-controllable robotic apparatus before it can damage itself.

25. The powered remote manipulator of claim 20 wherein the isolation circuit further comprises a drive cylinder, drive cylinder controlling valving connected to the drive cylinder, a master cylinder connected to the drive cylinder, a slave cylinder coupled to the master cylinder, a master/slave controlling valve set connected to the master and slave cylinders, and a hydraulic reservoir connected to the master/slave controlling valve set.

26. The powered remote manipulator of claim 20 wherein the at least two hydraulic cylinders of the shoulder joint are directly connected to the rotating drum.

27. The powered remote manipulator of claim 20 wherein the at least two hydraulic cylinders of the shoulder joint are connected to the rotating drum via at least two lengths of chain.

28. The powered remote manipulator of claim 20 wherein the shoulder joint further comprises a horizontally mounted slewing drive powered by an electric motor or hydraulic motor.

29. The powered remote manipulator of claim 20 wherein the shoulder joint further comprises a hydraulic actuator.

30. The powered remote manipulator of claim 20 wherein the attachable end effector is a hydraulic cylinder actuated gripper.

31. A robotic apparatus comprising:
a chain joint including a rotating drum having an attachment point, at least one hydraulic cylinder attached to the rotating drum, and at least one length of chain connecting the hydraulic cylinder to the rotating drum via the attachment point;
a proportional directional control valve connected to the chain joint to control flow of hydraulic oil to the chain joint; and
a dual counterbalance valve connected to the chain joint to manage load control of the chain joint and tension in the at least one length of chain.

32. The apparatus of claim 31, further comprising a pressure reducing valve connected to the chain joint to limit supplied pressure to the at least one hydraulic cylinder.

33. A containment system for a robotic arm comprising:
a boot covering a robotic arm having a gripper side and a wall side;
a sealed bearing clamped to the gripper side of the boot allowing the robotic arm to rotate and reorient itself without twisting the boot; and
a boot ring clamped to the wall side of the boot.

34. The containment system of claim 33, further comprising an interference lip retaining the boot ring to a cell wall.

35. The containment system of claim 33 wherein the boot ring further comprises at least two seals to isolate an interior of a cell wall.

36. The containment system of claim 33 wherein the boot ring is made of plastic allowing the boot ring to serve as a bearing surface for the robotic arm.
